(19) United States
(12) Patent Application Publication
(10) Pub. No.: US 2013/0159101 A1
(43) Pub. Date: Jun. 20, 2013

(54) METHODS FOR AND APPARATUS FOR AUTOMATED SALES REFERRALS LOCAL TO A PURCHASER

(71) Applicants: Robert Davidson, New York, NY (US); Fanny Chung Davidson, New York, NY (US); Belinda Womack, Sante Fe, NM (US); Dmitry Korobkov, Moscow (RU)

(72) Inventors: Robert Davidson, New York, NY (US); Fanny Chung Davidson, New York, NY (US); Belinda Womack, Sante Fe, NM (US); Dmitry Korobkov, Moscow (RU)

(21) Appl. No.: 13/607,750

(22) Filed: Sep. 9, 2012

Related U.S. Application Data
(60) Provisional application No. 61/561,248, filed on Nov. 17, 2011.

(51) Int. Cl. G06Q 30/06

(52) U.S. Cl. CPC G06Q 30/0631
USPC 705/14.53

(57) ABSTRACT

The present invention provides methods and apparatus for associating Emotional Motivators with a Product. The Emotional Motivators associated with the Products are correlated with Emotional Motivators associated with a Purchaser. Advice regarding a Purchase may be provided based upon the correlated Emotional Motivators.

### CROSS REFERENCE TO RELATED APPLICATIONS

The present application claims priority to provisional patent application Ser. No. 61/561,248, filed, Nov. 13, 2011 and entitled, “Methods and Apparatus for Automated Sales Referrals Local to a Purchaser”, the contents of which are relied upon and incorporated by reference.

### FIELD OF THE INVENTION

The present invention relates to methods and apparatus for arranging for a sale matching Products and Services with Emotional Motivators. Advice based upon the matched emotional motivators may be transmitted over a distributed network to a user or another interested party. The advice may include a referral to a vendor local to a Purchaser.

### BACKGROUND OF THE INVENTION

It has been known to make Product recommendations based upon specifications and/or descriptions of a Product. In addition, it has been known to provide ratings of Products based upon objective and subjective criteria. As a result, recommendations to purchase a Product have been made based upon technical attributes or an opinion of a third party about the Product.

In today's world, a Purchaser may also find it beneficial to receive such an opinion to assist the Purchaser in making a decision as to which Product or Service the Purchaser should select. A sheer number of choices presented by a number of products available and a number of vendors and venues, both online and brick and mortar, may be overwhelming. Pre-existing advice in the form of evaluations or technical specifications may simplify decision making, in particular in those scenarios where time constraints are faced by a user. Time pressures to make a decision on which Product or Service to purchase make it difficult for a Purchaser to conduct detailed research into various Products available. As a result, Purchaser is often forced into a decision to Purchase with little understanding about whether the Purchase will prove satisfactory to the Purchaser.

Product specifications with objective data and subjective opinions of a third party may be useful to a Purchaser, however, they do not adequately take into account what motivates a Purchaser to buy and also what motivates the Purchaser to feel they made a correct choice with a decision to buy a Product.

Essentially, there has not existed an automated tool which allows a user who is a potential purchaser to process data on various available products and equate those products on a personal basis in order to ascertain which Products will prove to be satisfactory to the Purchaser.

### SUMMARY OF THE INVENTION

Accordingly, the present invention provides methods and apparatus for associating Emotional Motivators and Emotional Qualifiers and to provide advice based upon the emotional motivators. Advice is based upon what would make a Purchaser conclude that a particular Purchase is success for that Purchaser.

In some embodiments, input may be received in to a computer server via a distributed network and processed to generate and association of one or more emotional motivators with a user, such as a Purchaser. One or both of Products and Services may also be associated with indicators of emotional motivators, or “emotional qualifiers”.

A software engine included in the server may be used to match the emotional motivators with the emotional qualifiers and provide advice based upon the match of the emotional motivators and emotional qualifiers. Emotional qualifiers represent which emotional motivators may be met by a particular Product or Service. In some preferred embodiments, emotional qualifiers are associated with “hard” dictionary classifications and “soft” dictionary classifications.

In some preferred embodiments the server provides a Purchaser with guidance relating to a purchase, a life event or other decision which may involve emotional motivators. An interactive assessment of the Purchaser's emotional motivators may be provided online and thereby become widely available for use by a Purchaser.

A related aspect of the present invention provides methods and apparatus for generating and presenting an interface which facilitates a user in making choices that will make that particular user happier with a choice, such as a purchasing decision. The interface may be presented over a distributed network, such as the Internet.

In some respects, the present invention may be implemented to determine what matters most to a user and then correlates a decision, such as which product to purchase, with that which motivates the user. In some preferred embodiments, steps directed to determining what matters most to a user are determined via “playful” activities. Other embodiments may include traditional question and answer input.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments of the present invention.

FIG. 1 illustrates a functional block diagram of some aspects of the present invention.

FIG. 2 illustrates a block diagram of functional modules that may be used to implement embodiments of the present invention.

FIG. 3 illustrates a block diagram of a purchase process that may be used to implement embodiments of the present invention.

FIG. 4 illustrates a block diagram of decision functions that may be included in some implementations of the present invention directed to a purchase decision.

FIG. 5 illustrates a block diagram of decision functions that may be included in some implementations of the present invention directed to a non-purchase decision

FIG. 6 illustrates a block diagram of functionalities that may be used to implement some aspects of the present invention directed to associating emotional attributes with Products.

FIG. 7A-7C illustrate block diagrams of exemplary user interfaces including functionalities that may be included in a user interface used to implement some embodiments of the present invention.

FIG. 8 illustrates apparatus that may be used to implement some embodiments of the present invention.

FIGS. 9A-9B include flow diagrams of method steps that may be experienced by a Purchaser in some implementations of the present invention.

FIG. 10 illustrates a block diagram of a relevancy rating system, which may be used in some embodiments of the present invention.

FIG. 11 illustrates a block diagram of Products being associated with Emotional Motivators or Qualifiers.

FIG. 12 illustrates a block diagram of real time Product status online.

FIG. 13 illustrates a flowchart of steps that may used to implement some embodiments of the present invention.

FIG. 14 illustrates a flowchart of additional steps that may used to implement some additional embodiments of the present invention.

### DETAILED DESCRIPTION OF PREFERRED EMBODIMENTS

The present invention provides recommendations to a Purchaser on purchases to be made local to the Purchaser. One or more Emotional Motivators may be associated with a Purchaser and Emotional Qualifiers may also be associated with one or more Products and/or Services. Automated apparatus, such as a computer server running executable software determines which Products are most likely to result in satisfaction to the Purchaser in the event the Purchaser acquires the recommended Product.

The automated apparatus is additionally functional to transmit to the Purchaser data descriptive of one or more merchants that are Local to the Purchaser. The automated apparatus also transmits an artifact which provides an incentive for the Purchaser to complete a purchase of the recommended Product from the Local merchant.

As described more fully below automated apparatus works in conjunction with processor and executable software, wherein the software is executable upon demand to assess emotional motivators related to making a purchase. Executable software is operative in conjunction with a processor to execute methodologies that match emotional motivators to purchasing decisions. Emotional motivators may be associated with one or more of: an individual actually making a purchase; a person who will receive a purchased good or service; and with a good or service which may be available for purchasing.

### GLOSSARY

As used herein the following terms will have the following associated meaning:

“Buying Context” includes circumstantial data related to a Purchase.

“Cross Channel” using data related to a first Purchase in a first subject area with a second Purchase or other decision in a second subject area.

“Emotional Reasons” as used herein Emotional Reasons means subjective emotional motivators that form a basis for satisfaction following completion of a decision, such as, for example, a decision to make a Purchase.

“Emotional Motivator” as used herein shall mean, a psychological factor associated with a user, such as a Purchaser, wherein the factor influences satisfaction with a decision.

“Emotional Qualifier” as used herein refers to a qualification associated with an inanimate Product or a Service, wherein the qualification may influence emotions associated with the Product or Service. An Emotional Qualifier may sometimes be referred to herein as an Emotional Motivator associated with an inanimate Product.

“Engine” as used herein refers to an apparatus including a processor that executes a software process to receive one or more inputs, process the inputs, and generate an output based upon the inputs.

“Local” in geographic proximity reasonable to travel to make a purchase based upon objective and subjective aspects of a purchase, which may include, for example a size of a purchase, the availability of a Product to be purchased and timing of when a Product is needed.

“Product” for the sake of simplicity in this discussion, as used herein a Product shall mean one or more of: a tangible item, machine or device; an intangible conveyance such as knowledge, know how or data stream; and a Service performed (as defined below).

“Purchaser” or multiple “Purchasers” as used herein shall mean one or more individuals, or a succinctly defined organization that makes or contemplates making a purchase.

“Service” as used herein shall mean an action performed at the request of a Purchaser.

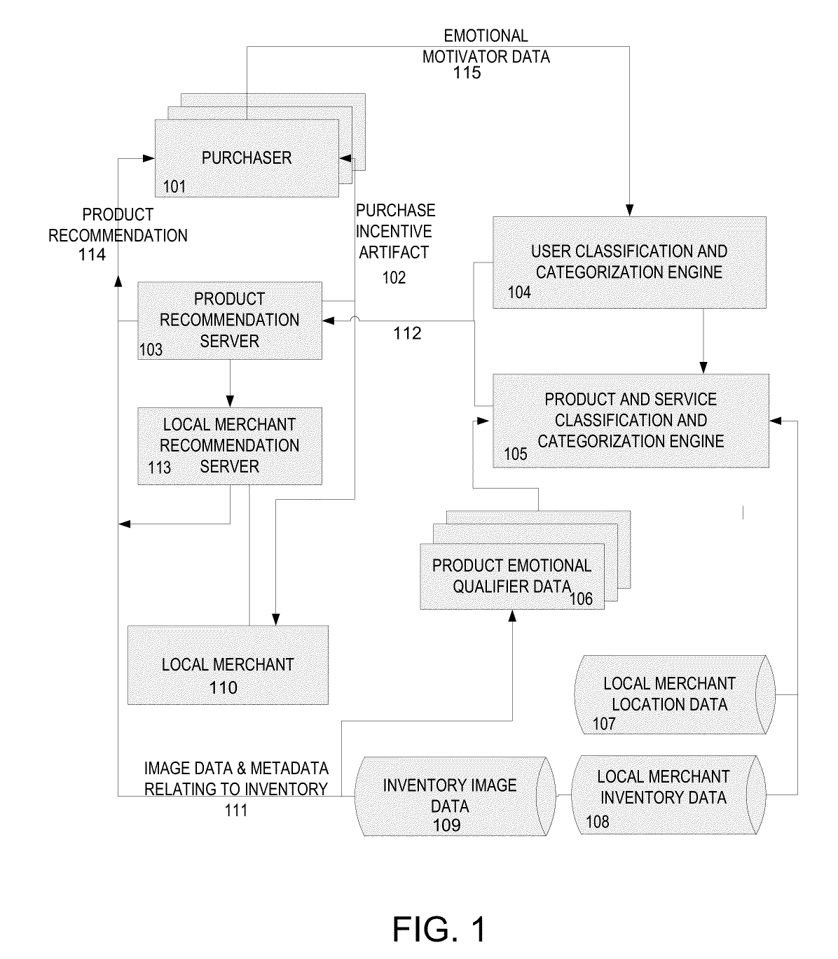

Referring now to FIG. 1, a functional block diagram illustrates aspects of wherein a Purchaser 101 receives a recommendation for a purchase of a Product (Product Recommendation 114) from a Local Merchant 110 and an incentive to purchase the Product from the Local Merchant 110. In some preferred embodiments, the recommendation for a purchase of a Product is based upon Emotional Motivators associated with the Purchaser 101 and Emotional Qualifiers associated with the Product.

As discussed more fully below, a User Classification and Categorization Engine 104, receives Emotional Motivator data 115 and associates Emotional Motivators with a Purchaser. In addition, a Product and Service Classification and Categorization Engine 105 receives Product Emotional Qualifier data 106 and associates Product and Service Qualifiers with a Product. A Product Recommendation Server 103 receives input via a digital communication 112 from the User Classification and Categorization Engine 104 and the Product and Service Classification and Categorization Engine 105 and transmits data to the Purchaser 101 descriptive of a Product Recommendation 114 based upon the data received.

According to the present invention, a Local Merchant Recommendation Server 113 identifies a Local Merchant 110 that is in geographic proximity to the Purchaser 101, wherein the Local Merchant 110 is identified as carrying the Product for the Purchaser 101 to buy. Geographic proximity implies the Local Merchant is within a distance reasonable to travel to make a purchase based upon objective and subjective aspects of a purchase, which may include, for example a size of a purchase, the availability of a Product to be purchased and timing of when a Product is needed.

In addition, the automated apparatus may transmit data descriptive of a Purchase Incentive Artifact 102 which includes an incentive for the Purchaser 101 to complete a purchase with the Local Merchant. In some preferred embodiments, the incentive will be directed towards a Product described in the Product Recommendation 114, although various embodiments may also include incentives for other Products similar to those in a Product Recommendation 114.

An Incentive Artifact may include for example, a virtual coupon that may be printed to become a physical coupon, or a virtual coupon displayed on a Smartphone or a personal digital assistant. As discussed further below, other Incentive Artifacts may include a bar code, a hash mark, a redemption code, an emblem mark or any other type of artifact that is capable of identifying an entity making the recommendation and hence referral.

In some embodiments the Incentive Artifact may include a discount entry field, or a redemption entry field, wherein the Purchase may scan a barcode, hash or other device, or enter a store code into a field entry to be processed by provider of the Product recommendation 114.

In another aspect, in some embodiments, the present invention may access data such as, local merchant location data 107, local Merchant inventory data 108 to determine which storefront may have a particular Product in stock. In addition, some embodiments may include access image data 109 descriptive of a recommended Product. Image Data and metadata descriptive of a Product may therefore be transmitted 111 to a Purchaser 101 for consideration by the Purchaser 101.

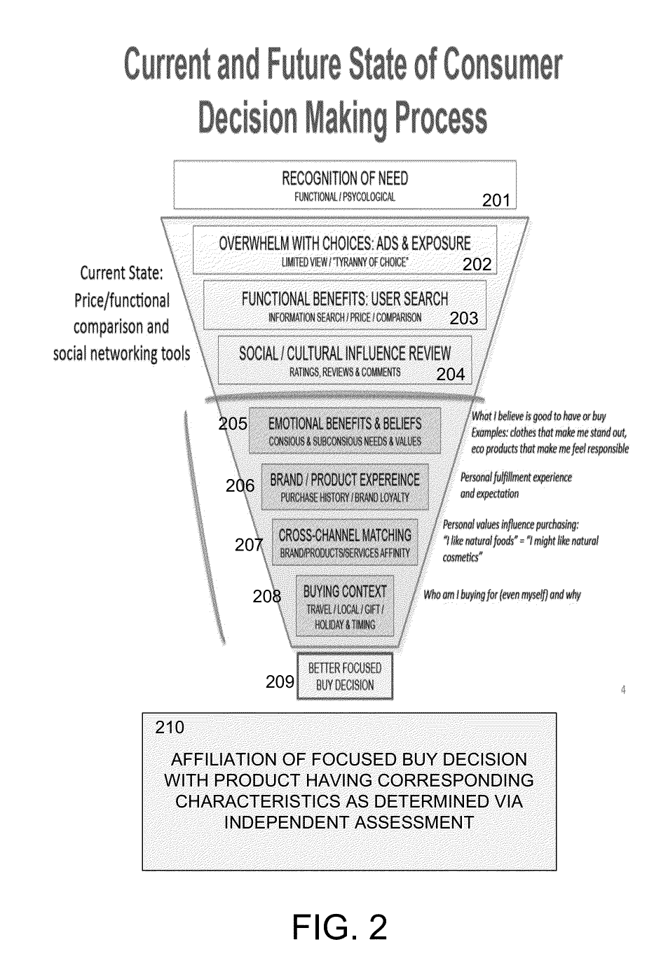

Referring now to FIG. 2, a block diagram illustrates a method for a Purchaser to make a decision to purchase a product or service. At 201, the Purchaser recognizes a need for one or both of a good and service. A need may be essentially objective and functional in nature, such as a portion of a defined process, for example a replacement part of a machine, such as an automobile. A need may also be subjective or psychological, such as a need to purchase an item to celebrate an event.

At 202, a Purchaser looking for input may be overwhelmed with choices, advertisements and exposure to media promoting select purchase choices. The view of product and service choices is also limited to those choices that are actively advertised and promoted. At 203, a Purchaser may search functional benefits. The search may reveal information about a product or service, a price and a comparison to other available products. At 204, social and cultural influence may also affect a purchasing decision. The social and cultural influence may include one or more of reviews, ratings and comments descriptive of products. Steps such as those described in 201-204 at best provide a broad amount of information but only partial in regard to a specific purchase event.

At 205, emotional benefits and beliefs are assessed wherein the emotional beliefs and benefits may be on a conscious, subconscious or unconscious level and values are accessed which are inherent in a Purchaser. In some preferred embodiments, discussed more fully below, a Purchaser will provide value related data as input into a computerized apparatus, wherein the data may be processed by a programmable algorithm to correlate the input data with one or more core values useful to make a purchasing decision. Emotional benefits may include, for example, whether a Purchaser believes that it is good to own or to buy Products that make the Purchaser stand out, or that it is good to own or to buy Products that are ecologically friendly and which make the Purchaser feel responsible.

Another example of an objective need may include a need for a carriage to carry a baby during a jogging activity. A need that is essentially subjective includes a need for a stylish baby carriage that will make the Purchaser appear chic.

At 206, in addition to value based data, the computerized apparatus may include one or both of brand and product experience. A purchase history may also be used, in addition to brand loyalty, or in place of brand loyalty.

At 207, in some embodiments, cross channel matching may be implemented. Cross-channel matching includes determining an emotional reason for affinity to a first one or more of: a brand, a Product; and a service. With Cross-Channel matching, one or more Emotional Reasons is stored and made available to be applied to at least a second one or more of: a brand, a Product; and a service. The application of the Emotional Reason to the second one or more of a brand, a Product; and a service, facilitates a recommended choice of purchase of the second brand, Product; or service.

At 208, a buying context may also be considered in making a recommendation of a purchase. A buying context may include, for example, whether the purchase will be: made during travel; from a local vendor (or at least a vendor with a local presence); for a gift for another person; is associated with a holiday; or has specific timing constraints. By way of non-limiting illustration, a buying decision may be for a gift that will be picked up during travel to a particular destination and during particular calendar days. In another illustrative example, a purchase may be for a person supplying emotional motivators and be for a purchase that will be made local on a same day as purchasing research is conducted.

At 209 a Purchaser is presented with a better focused buying decision. The focus may include a clear representation of who, what, where and when a purchase will be made.

At 210, the present invention correlates a Purchasers Emotional Motivators with a Product having corresponding Motivator characteristics as determined via an independent assessment of the Product (discussed further below).

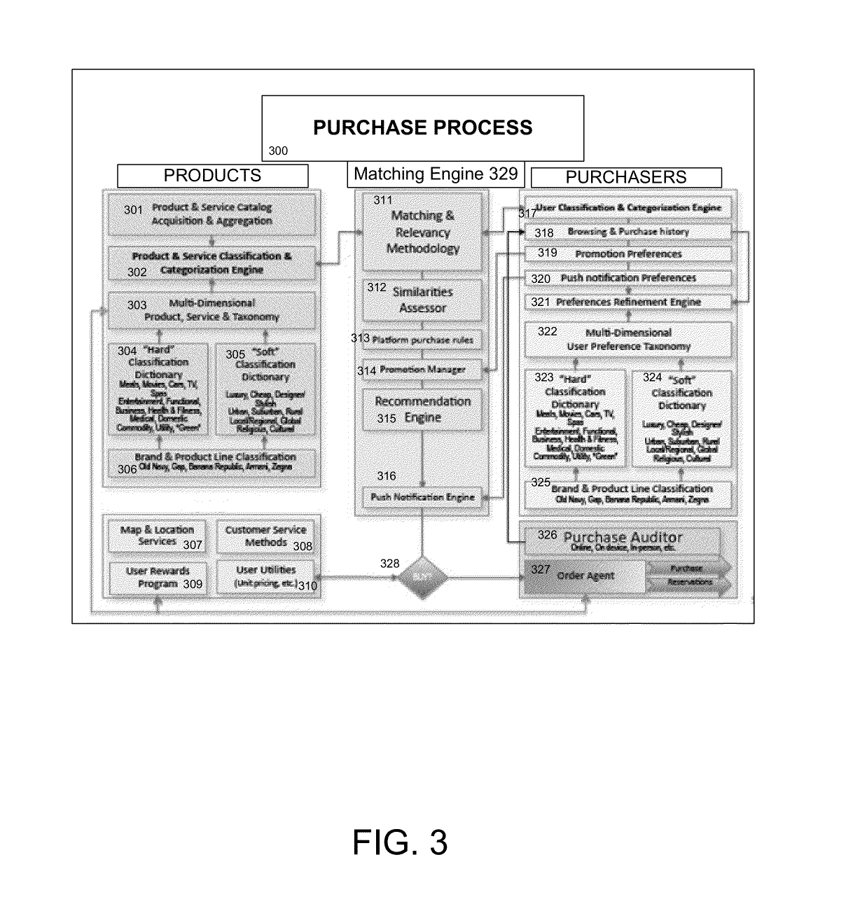

Referring now to FIG. 3, a process is presented according to some embodiments of the present invention. On a high level, the process includes method steps that may be implemented to practice novel aspects of the invention, including, for example, associating Emotional Motivators to Products and Services; associating Emotional Motivators with a Purchaser, and matching one or more Products and Services with a Purchaser. At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, and Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, and cultural or other taxonomy or classification which is essentially relative to other taxonomies.

At 306, some exemplary embodiments may also include a recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310, user utilities are provided that may include unit pricing, taxonomies, Product availability or other data.

A matching engine 329 may include automated apparatus including a processor, a digital storage device and executable software stored on the digital storage and executable upon command to match Products which may include goods and services with Purchasers. The Matching Engine 329 may include multiple functionalities 311-316, including, for example a matching and relevancy methodology 311. A Similarities Assessor 312 may include executable code for associating Emotional Qualifiers with products and Emotional Motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

Considering now a Purchaser and taxonomies and data that may be input indicative of the Purchaser's Emotional Motivators, items 318-327 include various aspects of data that may be included by a user categorization and classification engine (sometimes referred to herein as “CC Engine”) 317 practicing the method steps of the present invention. At 318, the CC engine 318 may receive and process data indicative of one or both of a browsing history and a purchasing history of a Purchaser. A CC Engines may receive and process data indicative of one or both of: promotion preferences of a Purchaser 319; and push notification preferences of a Purchaser 320. At 321, a Preferences refinement engine may correlate various Purchaser preferences and generate preference trends for a Purchaser. The Purchaser trends may be included in a multi-dimensional Purchaser preference taxonomy or other user preference taxonomy, generated by a computerized device implementing the present invention.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, cultural or other taxonomy or classification which is essentially relative to other taxonomies.

Classification systems may also include brand and Product classifications 325. Product and Brand classification may, for example, include associations of Emotional Qualifiers with Products and/or Brands, wherein the Products and Brands may thereby be associated with Emotional Motivators via the Emotional Qualifiers.

Product and brand classification 325 may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

A Purchaser may make a decision to execute a “Buy” action 328 and make a purchase. An order agent 327 may be used to implement a purchase instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

For example, during a first time period, a Purchaser may be primarily motivated by an Emotional Reason of wanting to be stylish or chic. This may correlate, with a period of financial success and significant social interaction. During a second time period, a Purchaser may be primarily motivated by an Emotional Reason of seeking high quality and durability. This period may correlate with a period of financial challenge and focus on raising a family, or other care giving.

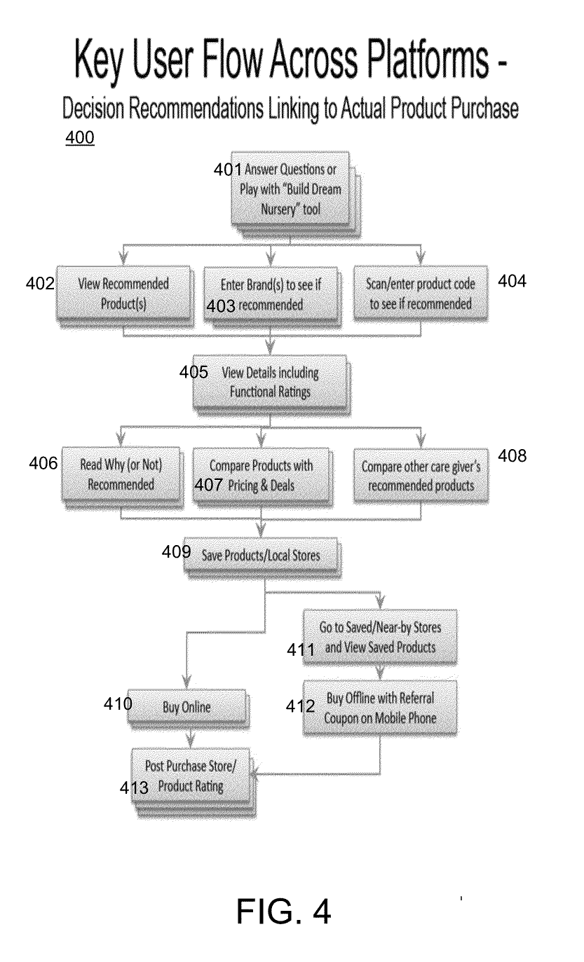

Referring now to FIG. 4, a block diagram illustrates a flow of key user functions across computerized apparatus platforms that may be implemented to facilitate a Purchaser's decision to make a Product purchase. As with other functional modules described herein, the key user functions may be implemented on a computerized device via executable software, executed upon demand. At 401, a Purchaser or other user, may provide input which may be used as input into a Motivator engine to determine primary Emotional Reasons the Purchaser will use to make a Purchase. The input may include, for example, answering questions presented to them about seemingly unrelated choices, or “playing” with an interactive virtual reality scene, such as a “Build a Dream Nursery” tool.

At 402, a computerized system implementing the present invention may allow the Purchaser to view Products which are recommended, based upon input received from the Purchaser. At 403, a Purchaser may also designate a Purchaser preferred brand and the system may indicate if the Purchaser preferred Brand is included in a list of recommended Products.

At 404, a Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

At 405, a Purchaser may view details including functional ratings of Products being considered by the Purchaser. The details and ratings may be compiled from multiple sources, including, for example, manufacturer specifications, independent reviews, online blogs, government agencies, ratings entities, or other source.

At 406-408, a Purchaser may receive feedback related to Products of interest to the Purchaser. At 406, feedback may include, for example, why a Product is recommended, or not recommended. At 407 relative prices and purchasing deals for recommended Products may be compared. At 408, Products recommended by other Product users, such as one or more other care givers may also be provided to the Purchaser.

At 409, in some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product.

At 410, a Purchaser may complete a purchase of a Product online via a virtual storefront, or a virtual exchange. At 411, a Purchaser may physically visit a store and view Products the Purchaser may potentially purchase. At 412 Purchaser may also make a Purchase in the local store. At 413, a Purchaser may provide to a Purchasing system feedback, such as a rating or other indication of the Purchaser's satisfaction with a purchased product or the suitability of a particular product for a purpose.

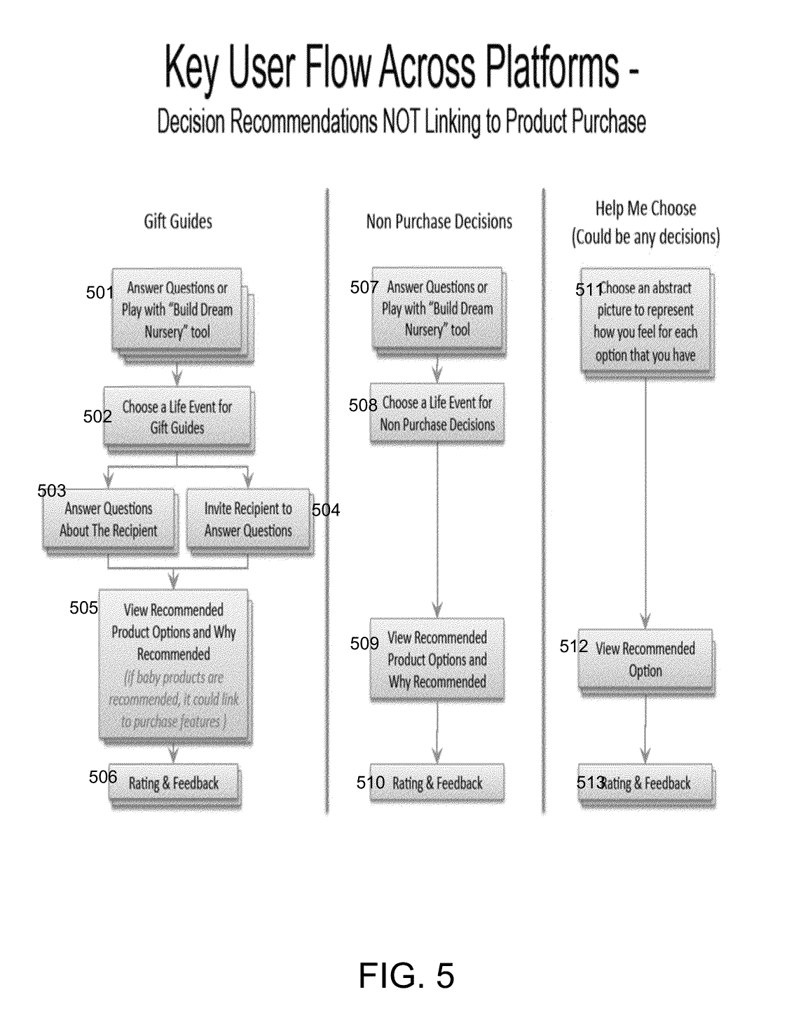

Referring now to FIG. 5, a block diagram illustrates a flow of key user functions across computerized apparatus platforms that may be implemented to facilitate purposes other than a Purchaser's decision to make a Product purchase. At 501-506 steps are illustrated which allow the present invention to be implemented in situations where a Purchaser is making a Purchase for a gift. At 501, a Purchaser may answer interview questions. In some embodiments, answers to questions are gleaned from an interactive activity. The interactive may be presented as a virtual game or a virtual tool. For example, one interactive activity may include a virtual “Build a Dream Nursery” activity. A Purchaser, or in some embodiments, a gift recipient or other relevant person, is encouraged to virtually create a nursery. The present invention, allows a computerized apparatus to track selections made in attributes of the nursery. The attributes chosen may be utilized in lieu of, or in addition to, answers to questions from the Purchaser or other user.

As part of input to an eventual Product recommendation for a given circumstance, at 502, a life event may be chosen for a gift guide. At 503, a Purchaser, or other user may provide answers about a gift recipient. The answers may be submitted to a computerized device via any known user interactive tool. In addition, at 504 in some embodiments, a gift recipient may be invited may be invited to provide answers to questions. For example, a gift recipient may be sent an electronic communication, such as one or more of: an email, a text, and a social media posting. The gift recipient may follow instruction included in the electronic invitation to a website which allows the gift recipient to identify themselves and answer the questions.

At 505, the present invention allows for one or both of the Purchaser (gift giver) and the gift recipient to view information in a human readable form that is descriptive of recommended Products. In some embodiments, the Purchaser and gift recipient are also provided with information descriptive of why one or more particular Products are recommended. At 506 one or both of the Purchaser and the gift recipient are provided with a user interactive interface for providing a rating on a Product and other feedback on one or more of: a Product; the recommendation; and the emotional motivator process for making recommendations.

In another aspect of the present invention, it is noted that an automated system which uses Emotional Reasons and Motivators to assist in decision making is not limited to decisions relating to potential purchases. Almost any decision may be assisted with an understanding and application of knowledge relating to underlying emotions and motivators.

At 507, a user may undertake one or more activities, such as answering questions or participating in a virtual activity. The virtual activity may include, for example, a game or a tool which provides queries to a user for instructions on how to create something online. At 508, in some embodiments, a life event may be associated with a non-purchase decision which will be made by a user. At 509, the user may view recommendations based upon the input received by, or about, the user. The recommendations may include, for example, one or more of: a recommended action step, or course of action; a Product selection; and a collaboration with a particular person or group of people. At 510 a user interactive interface may be implemented for providing a rating or other feedback on the services provided, such as how well a product recommended suits a Purchaser.

At 511, in a still broader, or more high level, implementation, a user may be asked to choose abstract picture or image which represents how a user “feels” or emotionally responds to one or more options presented to the user. At 512, the user or other party (such as a care taker, friend or employer) may view a recommended option. At 513, one or more of the user and another interested party (such as a care taker, friend or employer) may provide rating and feedback information.

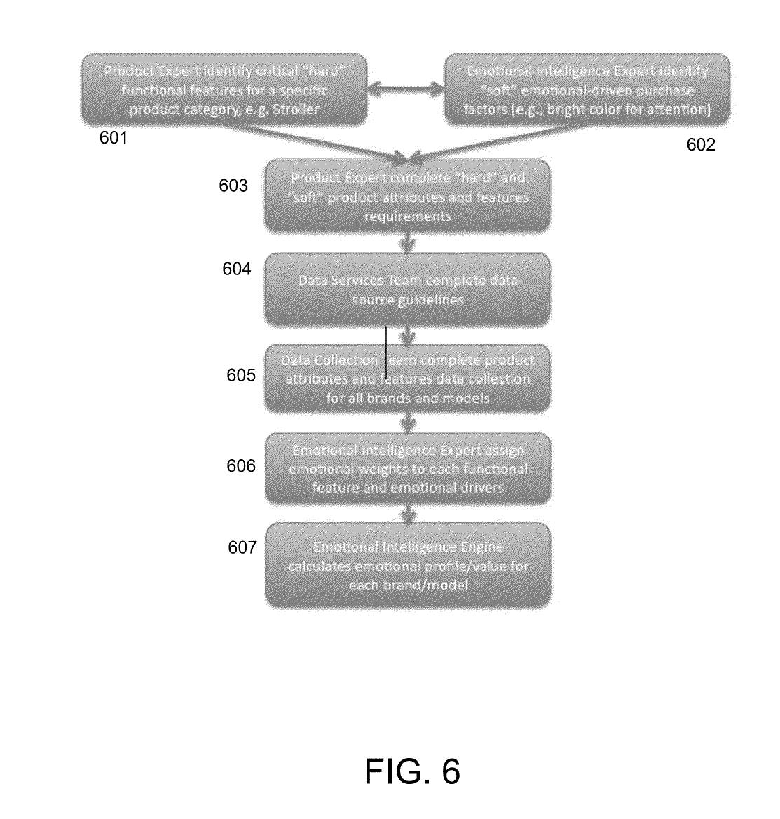

Referring now to FIG. 6, a block diagram illustrates how the present invention utilizes assessments of Products, and associates Products, with both “hard” functional attributes and “soft” emotional attributes.

At 601, the present invention receives input from one or more Product Experts which identify critical “hard” functional features for specific products category, such as, for example a baby stroller, an electronic device, a backpack, or almost any other Product. A hard functional feature may include for example, almost any empirical data, and may therefore include, for example, specifications, power ratings, physical dimensions, or other verifiable fact.

At 602, the present Emotional Intelligence Expert identifies one or more “soft” emotional-driven purchase factors. For example, a Product with a bright color may be associated with an emotional need for attention, a Product with rugged features and durability may be associated with a need to appear masculine. The soft features may be obtained from a database of available features and how those features may translate into, and evoke human emotions.

At 603, a Product Expert may complete a combination of hard and soft product attributes and feature requirements for a Product desired by a Purchaser or other user. At 604, a data services team may provide data source guidelines for a Product. The data source guidelines may include the data fields and definitions for datum that will be compiled for particular product groups. The data source guidelines will serve as an indication of which data fields should be collected for a particular Product, or Product group.

At 605, a data collection team may be tasked with providing the data fields specified by the Product Experts. The data collection may aggregate an input data values into a database which is made available to various engines to facilitate Product selection based upon Motivators and Emotional reasoning.

At 606, in some preferred embodiments, emotional weights are assigned to at least some, if not all of the functional features and emotional drivers. One natural choice is to have one or more emotional intelligence experts assign weights to functional features, and weights to emotional drivers. A weight may include, for example, an alpha numerical value that is associated with a relative scaled value. Other ratings or weights are also within the scope of the present invention, such as, for example, a color coded value.

At 607, in some preferred embodiments, an Emotional Intelligence Engine calculates a value which is associated with an emotional profile for a Product. The value associated with an emotional profile is preferably stored in a data structure which allows the value to be retrieved upon demand. The value may include multiple dimensions. For example, the value may include a scaled indication of an appearance of fiscal status, such as, for example, the brand name Louis Vitton™ may represent wealth, another emotional value may provide an indication of durability, another emotional value may provide an indication of subtleness or loudness. Other emotional values may be included within the scope of the invention, wherein any emotional value that may be influential in a Purchase decision or other decision at hand may be included.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, HDTV or other multimedia device with user interactive controls, including, in some embodiments, voice activated interactive controls.

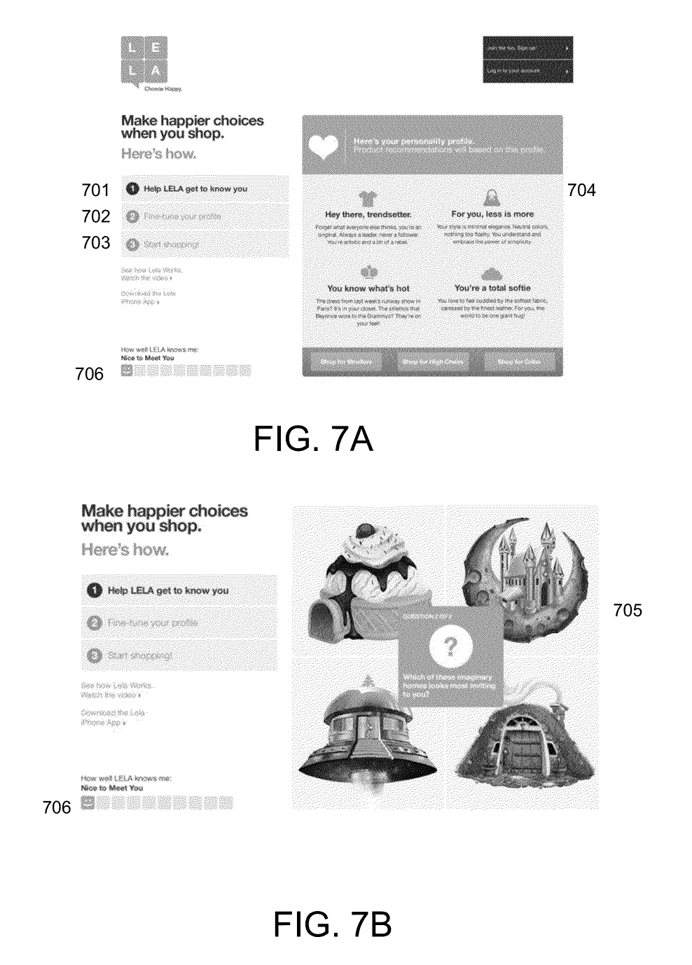

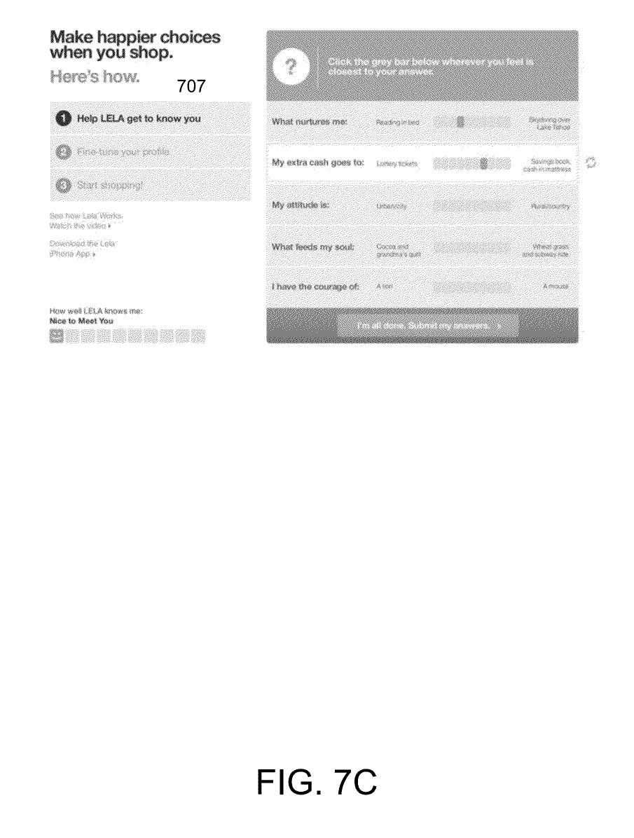

Referring now to FIG. 7A, an exemplary user interactive interface is illustrated. The interface includes multiple user interactive areas which may receive input from a user and provide one or both of human readable content or human recognizable images. Interactive areas may include, by way of non-limiting example, one or more of: a) a user interactive area on a screen that prompts a user of “Help LELA get to know you” 701; b) Fine tune your Profile 702; c) Start Shopping 703.

The Help LELA get to know you interactive area 701 is illustrative of a service such as the LELA™ service. This area 701 may be selected by a user to lead the user through a series of interactive queries designed to educate a LELA software engine about a user. For example, in some preferred embodiments, images may be presented to a user wherein the user is prompted to select one of multiple images in response to one or more questions. In addition, questions may be presented in sentence format and also be used to help LELA “know” the user. In some embodiments, the LELA questions are designed to have the user provide answers that are indicative of one or more emotional motivators that influence the user.

At 702 the user may also be provided with an area that allows the user to “fine tune” or otherwise modify the user profile, including emotional motivators. In some embodiments, a user may use interactive user devices such as icons and prompts to request a new set of images related to a question or to request one or more new questions.

At 703, a user may also choose to begin shopping with assistance of a LELA™ program that relates one or more Products with emotional motivators associated with the user.

At 704, another user interactive area may include an area that provides feedback indicating what Emotional Motivators are associated with the user.

Referring now to FIG. 7B, additional user interactive areas may also include an area that provides an indicator of how well LELA™ know the user. Essentially, how well LELA™ knows a user may be based upon, for example, one or more of: a number of questions answered by the user a number of images chosen by the user; a number of transactions executed by the user, a browsing history, or other forms of input.

At 705, a group of exemplary images is presented, wherein each image is indicative of one or more emotional motivators. Selection of an image by a user may provide input to LELA™ Emotional Motivators that may influence a user. At 706, an indicator of how well a user is being serviced by a provider of an interactive interface.

Referring now to FIG. 7C, in some preferred embodiments, a user interface 707 that receives input indicating emotional motivators of a Purchaser or other user may include questions that have two questions on a scale, wherein the Purchaser provides a scaled answer along a continuum formed between the two answers. For example, a Purchase may be queried as to what nurtures the Purchaser. Two answers, such as 1) “reading in bed” and 2) “skydiving over Lake Tahoe”. A scale between the two phrases may have a number of positions with some positions closer to the first answer and some positions closer to the second answer and a position equally distant from the first answer and the second answer. The position chosen provides a weighted indication of an answer closes to how a Purchaser feels. As illustrated, multiple questions and weighted answers along respective scales may be provided.

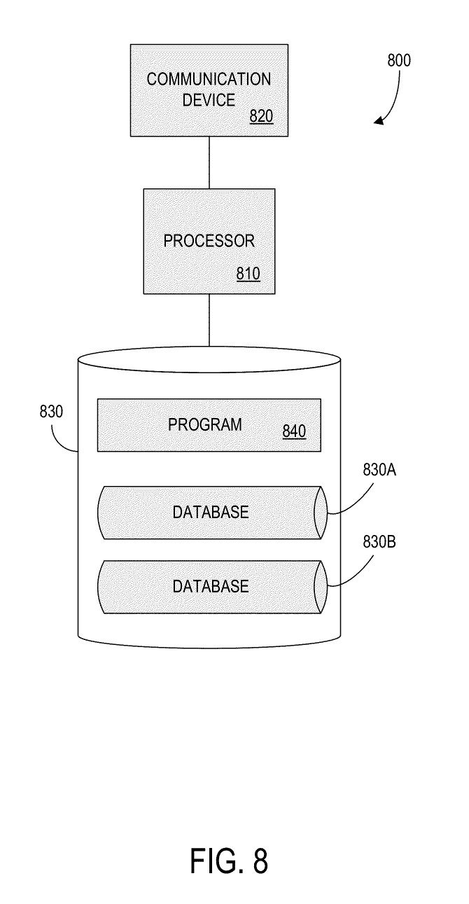

Referring now to FIG. 8, an illustration is provided with a controller 800 that may be embodied in one or more computer servers or communication network access devices and utilized to implement some embodiments of the present invention. A server may include, by way of example, a rack mounted server, stand alone server, a server farm or other embodiment of an automated apparatus for serving content on a communications network, such as the internet. Communications accessible devices may include, by way of example, a hand held device such as a cellular phone, a pad device, a personal computer, a server, a personal digital assistant, an electronic reader device or other programmable device.

The controller 800 comprises a processor unit 810, which may include one or more processors, coupled to a communication device 820 configured to communicate via a communication network, such as the Internet, or a other cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with the present invention. The processor 810 may also cause the communication device 820 to transmit information, including, in some instances, control commands to operate apparatus to implement the processes described above. The storage device 830 can additionally store related data in a database 830A and database 830B, as needed.

Methods

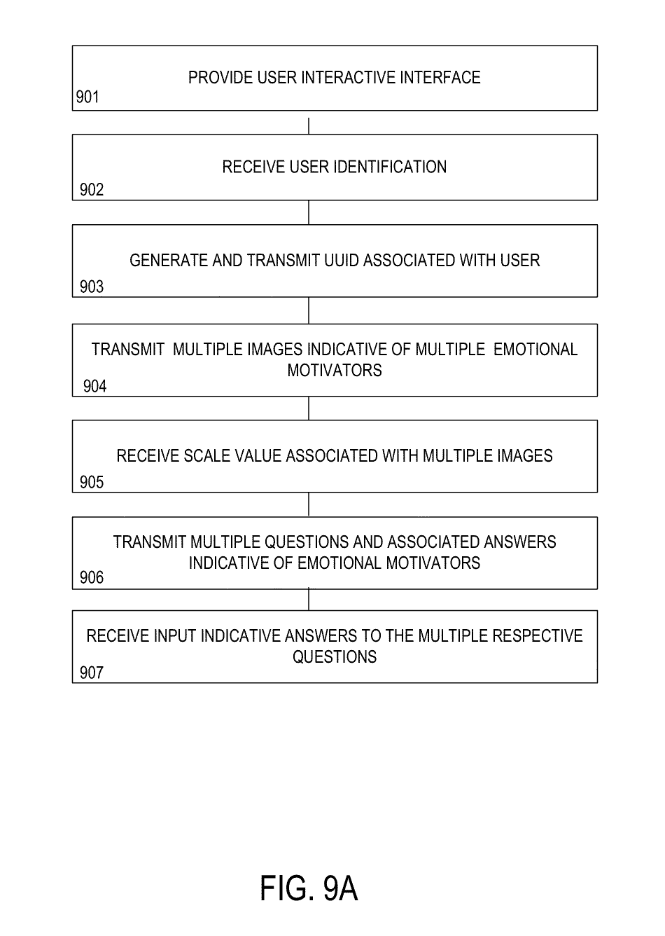

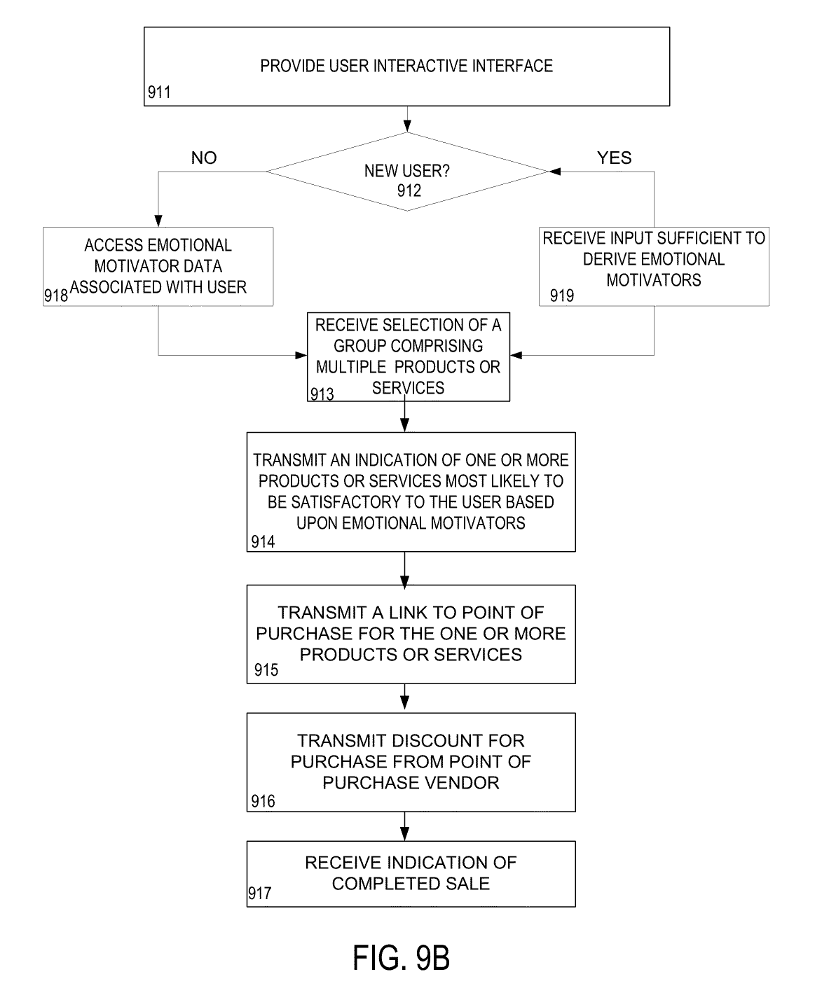

Referring now to FIG. 9, a flow chart with method steps that may be incorporated into some embodiments of the present invention. The method steps are presented as exemplary and are not required to be executed in a particular order.

At 901, a computer server may be used to provide a user interactive interface to a user, such as a Purchaser, who is contemplating a purchase. The purchase may be either themselves or for a beneficiary. The user may access the provided interactive interface across a communications network, such as the Internet or via a mobile phone network, such as, for example, a 3G or 4G network or other cellular or WiFi network.

At 902, the server may receive user identification and at 903 the server may transmit a unique identifier, such as, for example in some embodiments, a UUID (universally unique identifier).

At 904, the server may transmit multiple images, wherein each respective image is indicative of one or more emotional motivators. At 905, the server may receive input indicative of which image or images represent an answer to a question provided to the user related to the multiple images.

At 906, the server may transmit one or more questions relating to emotional motivators. Questions may be presented, for example via written text or via audio. At 907, the server may receive input indicative of an answer to the multiple respective questions. Answers to the multiple questions will be used to associate emotional motivators with the user.

Referring now to FIG. 9B, additional method steps that may be used to implement some embodiments of the present invention. At 911, a server may provide an interactive interface, some preferred embodiments may include access via the Internet or via a mobile phone network, such as, for example, a 3G or 4G network or other cellular or WiFi network.

At 912, the server may determine whether the user is a new user or already has a profile including emotional motivator data associated with the user. If the user already provided data indicative of the users' emotional motivators, at 918 the server will access emotional motivator data associated with the user.

If the user is a new user, or for some other reason the server does not have data associated with the user, at 919, the server may receive sufficient data to associate or otherwise derive emotional motivators with the user.

At 913, the server may receive a user's selection of a group including multiple products or services. At 914 the server transmits an indication of one or more Products or Services most likely to be satisfactory to the user based upon the emotional motivators associated with the user.

At 915, the server will transmit a link to the user. The link will include one or more of: text, imagery and code to direct the user to a point of purchase for the one or more Products and/or Services indicated to be satisfactory to the user, based upon the correlation of the user's emotional motivation and the Product Emotional. In some embodiments, the point of purchase may be a virtual storefront, or other electronic marketplace or webpage, wherein the Purchaser may complete a purchase of a Product via a linked Internet site. In other embodiments, the point of purchase may include a brick and mortar store. A brick and mortar store may include one or more stores determined to be geographically accessible to the user, such as a brick and mortar store in close proximity to the user, such that the user may reasonably travel to the store and make a purchase. A reasonable travel may be based upon a time and cost of travel in relation to a pecuniary value associated with a related Product purchase.

At 916, in order to entice user to become a Purchaser, the server may transmit to the user an artifact which is redeemable at the storefront (or other point of purchase) for a discount or other incentive based upon purchase of the recommended Product. The discount may be embodied in the form of a coupon, a rebate, a code, a specific link, or other artifact for conveying discount information. In some preferred embodiments, the discount includes a reference to a provider of a service that processes the emotional motivator data. At 917, the user may complete the sale.

### Conclusion

A number of embodiments of the present invention have been described.

Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

### Product Block Diagrams

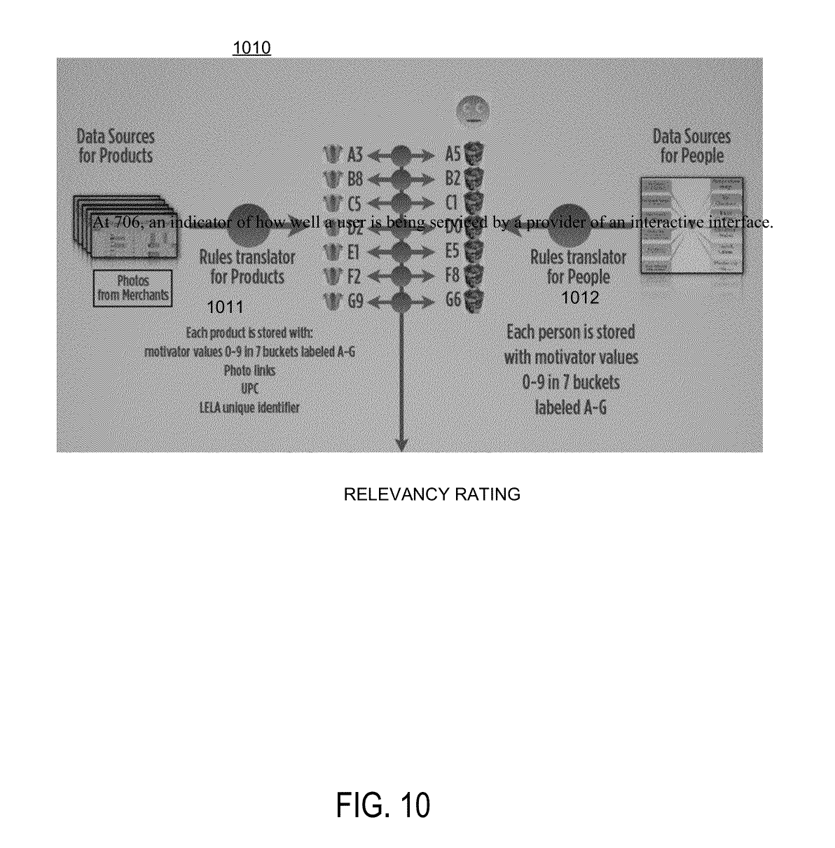

Referring now to FIG. 10, relevancy rating system is illustrated that may be implemented on a server or other computerized apparatus to execute a software engine 1010 that processes data to associate a Product with Emotional Qualifiers or Emotional Motivators.

In some embodiments, one or more Products are associated with an Emotional Motivator value of between 1 through 9 in multiple respective categories, such as, for example, seven buckets A through G at 1011.

In some embodiments, additional data may also be aggregated and stored, such as, by way of example, a UPC code, photos or links to photos, and a unique identifier, such as, for example a UUID (universally unique identifier). Product attributes may be matched with attributes associated with a user.

A rules translator 1012 may also store data associated with motivator values and be stored in data sources for people.

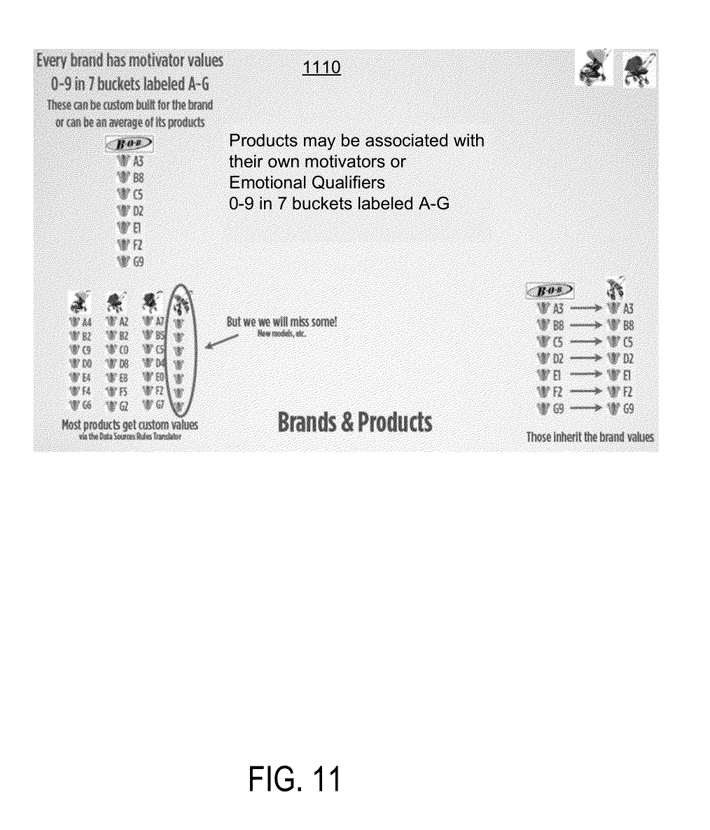

Referring now to FIG. 11, in some embodiments, a brand of one or more Products may be associated with Emotional Motivators or Qualifiers 1110. A brand may also be associated with an Emotional Motivator value of between 1 through 9 in multiple respective categories, such as, for example, seven buckets A through G.

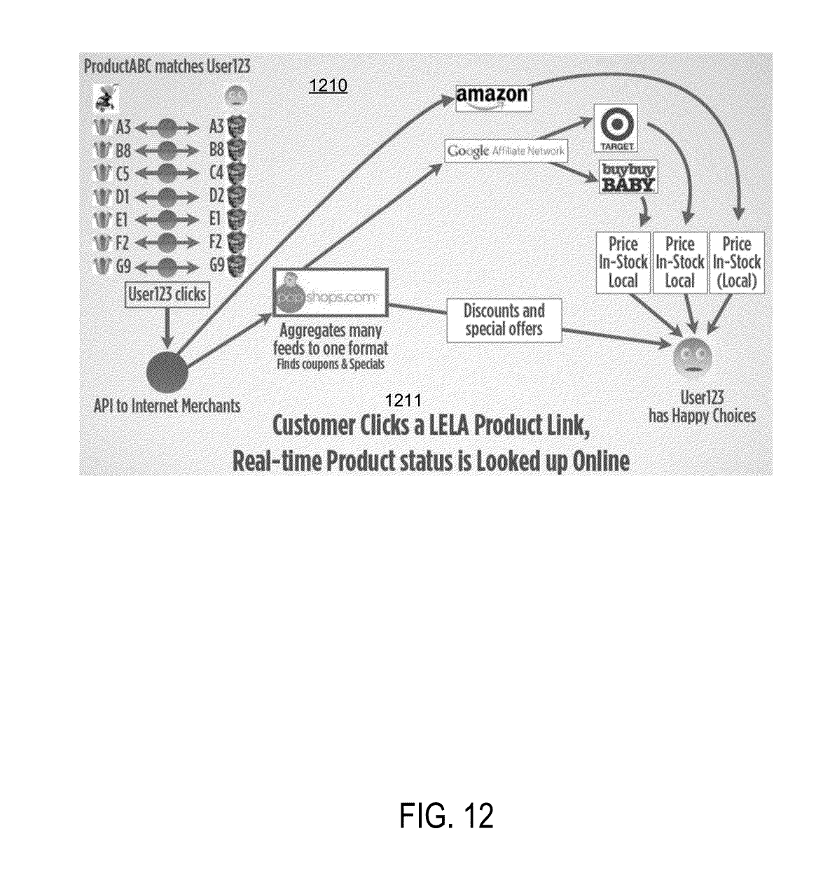

Referring now to FIG. 12 illustrates a block diagram 1210, a how a Purchaser may be linked to an online resource for acquiring a Product and also use of a real time Product status 1211 which may be made available online on a distributed network, such as the Internet.

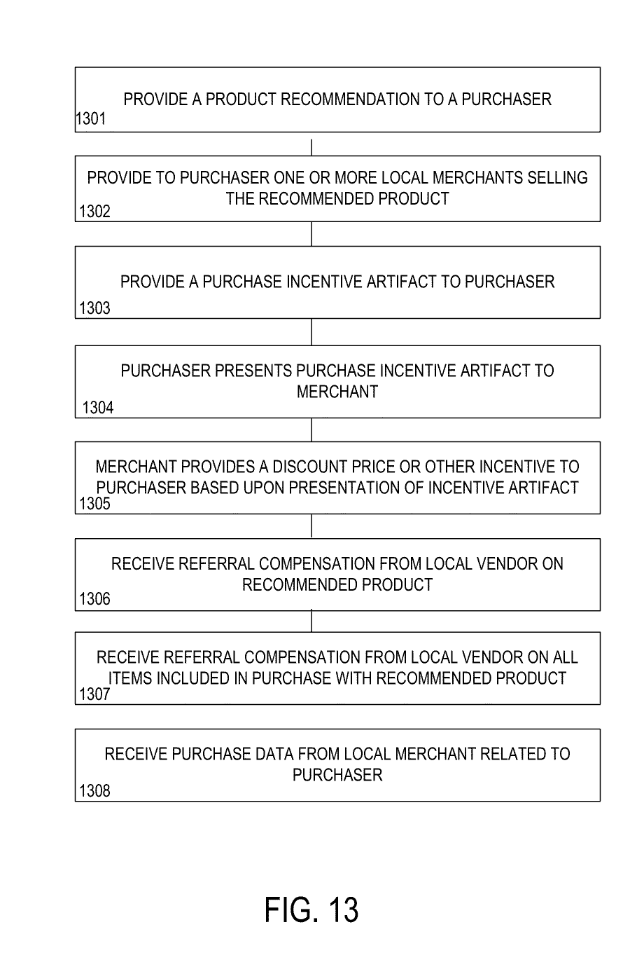

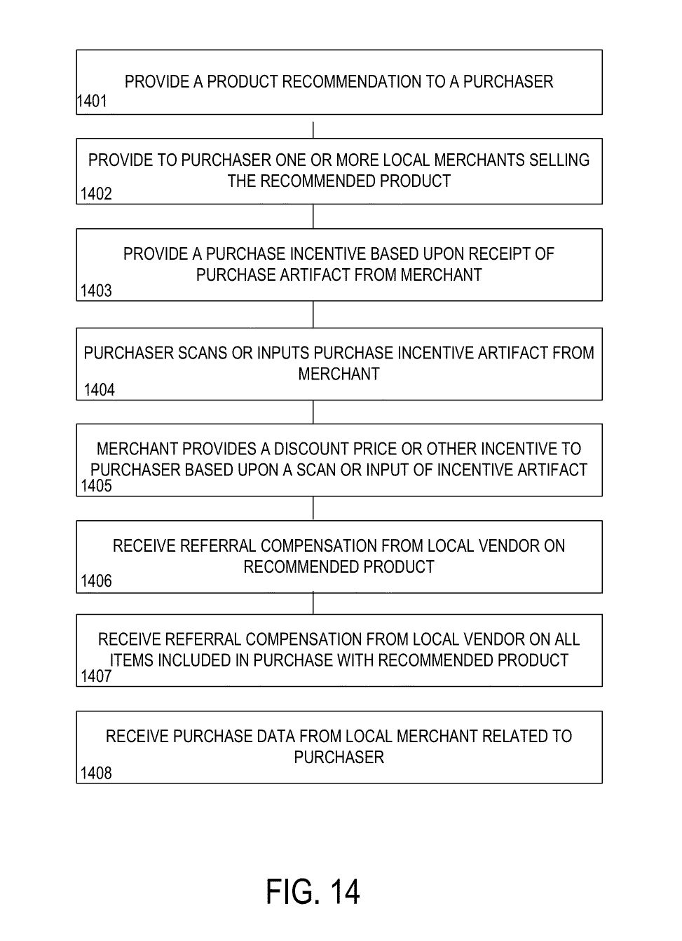

Referring now to FIG. 13 and FIG. 14, exemplary method steps that may be implemented in some embodiments are presented. The steps are not limited to any particular order unless other specified herein.

At 1301 a server or other automated computer device, or online service, may provide to a Purchaser a Product recommendation. In preferred embodiments, the Product recommendation is based upon Emotional Motivators and Emotional Qualifiers as described herein.

At 1302, the server may also provide to the Purchaser with data descriptive of one or more Local Merchants that sell the recommended Product. Additional data such as inventory data, product specifications, and images of the Product may also be included if desired. At 1303, a Purchase incentive artifact may also be transmitted to the Purchaser. The Purchase incentive artifact may include, for example, a coupon, a bar code, a UUID, a purchase code, a hash mark or other artifact identifiable by the Local merchant.

At 1304, the Purchaser may present the incentive artifact to the Local Merchant at the time of purchase and, at 1305; the Local Merchant may provide a discount price or other incentive to the Purchaser. Other incentives may include, for example, store credit, accessories, service warranty or other items of value.

At 1306, a provider of the recommendation will receive referral compensation, from the Local Merchant. Referral compensation may include, for example, a currency amount based upon an amount of a purchase price for a recommended Product, such as for example between 1% and 15% of the purchase price of the recommended Product; a currency amount based upon an amount of a purchase price for a sale that includes the sale of a recommended Product and other items (at 1307); a set referral fee, a scaled fee based upon an aggregate amount of sales for a time period, such as a monthly commission amount or other financial arrangement.

At 1308, in some preferred embodiments, a provider of recommendations may receive purchase data from one or more Local Merchants related to purchases made by one or more Purchasers. Purchase data may include data on just recommended Products or on all items sold to the Purchaser. Similarly, Purchase data may include data based upon an aggregate of sales or sales related to specific Purchasers.

At 1401, a server or other automated computer device, or online service, may provide to a Purchaser a Product recommendation. In preferred embodiments, the Product recommendation is based upon Emotional Motivators and Emotional Qualifiers as described herein.

At 1402, the server may also provide to the Purchaser with data descriptive of one or more Local Merchants that sell the recommended Product. Additional data such as inventory data, product specifications, and images of the Product may also be included if desired. At 1403, a Purchase incentive artifact may also be provided to the Purchaser by a Local Merchant. The Purchase incentive artifact may include, for example, a coupon, a bar code, a UUID, a purchase code, a hash mark or other artifact identifiable by the Local merchant.

At 1404 the Purchaser may scan a purchase incentive artifact or input a code or otherwise quantify the Purchase incentive artifact and send a description of such artifact to the Product recommendation entity. At 1405 the Merchant provides a discount price or other incentive to the Purchaser based upon the incentive artifact. At 1406, the Product recommending entity may receive a referral compensation, as described above, for the Product Purchase referral, or on an entire Purchase (at 1407).

At 1408, in some preferred embodiments, a provider of recommendations may receive purchase data from one or more Local Merchants related to purchases made by one or more Purchasers. Purchase data may include data on just recommended Products or on all items sold to the Purchaser. Similarly, Purchase data may include data based upon an aggregate of sales or sales related to specific Purchasers.

What is claimed is:

1. Apparatus for matching products and services emotional motivators, the apparatus comprising:
a computerized server in logical communication with a digital communications network; and
executable software stored on the server and executable on demand, the software operative with the server to cause the apparatus to:
receive a respective digital quantifier rating indicative of a scaled value for each of multiple Emotional Motivators associated with a Product;
receive a respective scaled value for each of multiple Emotional Motivators associated with a Person;
associate the scaled value for each of the multiple Emotional Motivators associated with a Person with the respective digital quantifier rating indicative of a scaled value for each of multiple Emotional Motivators associated with a Product;
transmit one or more recommended Products based upon the association of the scaled value for each of the multiple Emotional Motivators associated with a Person with the respective digital quantifier rating indicative of a scaled value for each of multiple Emotional Motivators associated with a Product;
transmit data descriptive of one or more local merchants selling the recommended Product; and
transmit a sales incentive artifact for use in conjunction with a purchase of the Product from the one or more of local merchants.

2. The apparatus of claim 1 wherein the software is additionally operative to transmit a discount artifact entitling the Purchaser to a discounted price for one or more of the Products determined to be satisfactory to the Purchaser based upon correlation of Emotional Motivators associated with the Purchaser and Emotional Qualifiers associated with the Purchaser.

3. The apparatus of claim 2 wherein the software is additionally operative to transmit a link to a virtual point of purchase for one or more of the Products determined to be satisfactory to the Purchaser based upon emotional motivators associated with the Purchaser and Emotional Qualifiers associated with the Product determined to be satisfactory to the Purchaser.

4. The apparatus of claim 2 wherein the software is additionally operative to transmit a link to a physical point of purchase for one or more of the Products determined to be satisfactory to the Purchaser based upon emotional motivators associated with the Purchaser and Emotional Qualifiers associated with the Product determined to be satisfactory to the Purchaser, wherein the physical point of purchase transmitted is additionally based upon geographical location of physical point of purchase and the location of the Purchaser.

5. The apparatus of claim 1 wherein the software is additionally operative to transmit data descriptive of emotional motivators associated with the Purchaser.

6. The apparatus of claim 1 wherein the software is additionally operative to transmit data comprising a history of Purchase transactions completed by the Purchaser.

7. The apparatus of claim 1 wherein the software is additionally operative to transmit data descriptive of a history of inputs comprising indications of emotional motivators associated with the Purchaser.

8. The apparatus of claim 1 wherein the software is additionally operative to transmit an indication of how well a software engine designed to quantify emotional motivators is aware of Purchaser preferences based upon emotional motivators.

9. The apparatus of claim 1 wherein the software is additionally operative to transmit data descriptive of emotional motivators associated with the Purchaser.

10. The apparatus of claim 1 wherein the software is additionally operative to transmit emotional qualifiers associated with a Product chosen by the Purchaser.

11. A method for matching products and services based upon emotional motivators, the method comprising the steps of:
receiving on a computer server a respective digital quantifier rating indicative of a scaled value for each of multiple Emotional Motivators associated with a Product;
receiving on the computer server a respective scaled value for each of multiple Emotional Motivators associated with a Person;
associating the scaled value for each of the multiple Emotional Motivators associated with a Person with the respective digital quantifier rating indicative of a scaled value for each of multiple Emotional Motivators associated with a Product;
transmitting one or more recommended Products based upon the association of the scaled value for each of the multiple Emotional Motivators associated with a Person with the respective digital quantifier rating indicative of a scaled value for each of multiple Emotional Motivators associated with a Product;
transmitting data descriptive of one or more local merchants selling the recommended Product; and
transmitting a sales incentive artifact for use in conjunction with a purchase of the Product from the one or more of local merchants.

12. The method of claim 11 wherein the method additionally comprises the step of transmitting a discount artifact entitling the Purchaser to a discounted price for one or more of the Products determined to be satisfactory to the Purchaser based upon correlation of Emotional Motivators associated with the Purchaser and Emotional Qualifiers associated with the Purchaser.

13. The apparatus of claim 12 wherein the method additionally comprises the step of transmitting a link to a virtual point of purchase for one or more of the Products determined to be satisfactory to the Purchaser based upon emotional motivators associated with the Purchaser and Emotional Qualifiers associated with the Product determined to be satisfactory to the Purchaser.

14. The apparatus of claim 12 wherein the method additionally comprises the step of transmitting a link to a physical point of purchase for one or more of the Products determined to be satisfactory to the Purchaser based upon emotional motivators associated with the Purchaser and Emotional Qualifiers associated with the Product determined to be satisfactory to the Purchaser, wherein the physical point of purchase transmitted is additionally based upon geographical location of physical point of purchase and the location of the Purchaser.

15. The method of claim 11 wherein the method additionally comprises the step of transmitting data descriptive of emotional motivators associated with the Purchaser.

16. The method of claim 11 wherein the method additionally comprises the step of transmitting data comprising a history of Purchase transactions completed by the Purchaser.

17. The method of claim 11 wherein the method additionally comprises the step of transmitting data descriptive of a history of inputs comprising indications of emotional motivators associated with the Purchaser.

18. The method of claim 11 wherein the method additionally comprises the step of transmitting an indication of how well a software engine designed to quantify emotional motivators is aware of Purchaser preferences based upon emotional motivators.

19. The method of claim 11 wherein the method additionally comprises the step of transmitting data descriptive of emotional motivators associated with the Purchaser.

20. The method of claim 11 wherein the method additionally comprises the step of transmitting one or more images associated with a Product chosen by the Purchaser.
